(19) United States
(12) Patent Application Publication
(10) Pub. No.: US 2002/0008841 A1
(43) Pub. Date: Jan. 24, 2002

(54) FLAT DISPLAY DEVICE HAVING A LIQUID CRYSTAL PANEL

(76) Inventor: KATSUFUMI OHMURO, KAWASAKI-SHI (JP)

Correspondence Address: GREER BURNS & CRAIN LTD, 300 S WACKER DRIVE, SUITE 2500- SEARS TOWER, CHICAGO, IL, 60606, US

(21) Appl. No.: 09/280,954

(22) Filed: Mar. 29, 1999

(30) Foreign Application Priority Data
Sep. 11, 1998 (JP) 10-258795

(51) Int. Cl. G02F 1/13

(52) U.S. Cl. 349/202

(57) ABSTRACT

A display device includes an optical source producing an optical beam with a wavelength shorter than about 500 nm, a liquid crystal panel disposed adjacent to the optical source for controlling the optical beam, and a layer of luminescent substance provided inside said liquid crystal panel.

### BACKGROUND OF THE INVENTION

The present invention generally relates to display devices and more particularly to a direct-view type flat display device having a high luminosity and a wide viewing angle.

There is a type of display device called flat display device. A flat display device generally has a thin, flat configuration and is characterized by a small power consumption. Thus, flat display devices are expected to play an important role in future information processing apparatuses ranging from television sets to computers.

As a direct-view type flat display device, various devices of different operational principles are proposed so far. These display devices include a plasma display device (PDP), a field emission display (FED) panel, a liquid crystal display (LCD) panel, and the like, wherein each of these various display devices has merits and demerits pertinent thereto. For example, a PDP is suitable for realizing a large display area, while a PDP simultaneously has a drawback in that it is difficult to realize a high-definition representation. A FED panel is suitable for a high-definition representation while it is simultaneously not suitable for a wide area representation because of the excessive cost. An LCD panel is suitable for a high-definition representation over a wide display area, while an LCD panel simultaneously has a problem in that a high-luminosity representation is difficult.

In view of foregoing various merits and demerits of conventional flat display devices, there is a proposal of a high-luminosity flat display device that uses a liquid crystal panel for overcoming the problems of conventional flat display devices. According to this proposal, a liquid crystal panel is used to spatially modulate an ultraviolet beam and the ultraviolet beam thus modulated is used to drive luminescent dyes provided on a display surface. As the representation of images is achieved in such a high-luminosity flat display device as a result of excitation of the luminescent dyes, the problem of limited viewing angle pertinent to an LCD panel is successfully avoided. Further, because of the use of the liquid crystal panel for driving the luminescent dyes, a high-definition representation comparable to that of a liquid crystal display device is achieved easily.

Japanese Laid-Open Patent Publication 63-172120 describes a color display device that uses a liquid crystal panel for spatially modulating a ultraviolet beam and driving a fluorescent substance on a display surface by such a modulated ultraviolet beam. Further, Japanese Laid-Open Patent Publication 8-62602 describes a flat panel display device that uses a back light source producing a ultraviolet beam with a primary wavelength range of 380-420 nm, in combination with a liquid crystal panel or an electro-optic panel for spatially modulating the ultraviolet beam produced by the back light source. The ultraviolet beam thus modulated spatially is used to drive the fluorescent substance on the display surface. Further, Japanese Laid-Open Patent Publication 8-36175 describes a flat display device having a construction similar to that of a conventional color liquid crystal display device, except that RGB (Red, Green, Blue) color filters are replaced by RGB fluorescent substances. Thereby, the RGB fluorescent substances are excited by the ultraviolet beam incident thereto through the liquid crystal layer.

However, such conventional flat display devices have suffered from the problem, associated with the use of a liquid crystal panel or an electro-optic panel for spatially modulating a ultraviolet beam, in that the ultraviolet beam has to travel over a substantial distance to reach the fluorescent substance on the display surface. On the way to the display surface, the ultraviolet beam for a given pixel may undergo a divergence and there may be caused a mixing of color as a result of such a divergence of the ultraviolet beams of adjacent pixels. In the case of a liquid crystal panel, it should be noted that the layer of liquid crystal is sandwiched by a polarizer and an analyzer. In such a construction, the display surface coated with fluorescent substance has to be disposed outer side of the analyzer. Thereby, the ultraviolet optical beam has to travel at least over a path traversing the polarizer, a first glass substrate at the side of the polarizer, the liquid crystal layer, a second glass substrate at the opposite side of the polarizer, and the analyzer.

Further, such a conventional flat display device that uses a polarizer and analyzer for spatial modulation of ultraviolet beam has a drawback of low optical efficiency and high optical loss. In order to realize a high luminosity representation in such conventional flat display devices, it has been necessary to use a powerful ultraviolet source. Further, in order to avoid the foregoing problem of mixing of color, it is necessary to provide a complex and expensive optical system for directing the ultraviolet beam of the optical source perpendicularly to the liquid crystal panel.

Meanwhile, there is a proposal, in such a flat display device that uses the optical excitation of fluorescent substances by a spatially modulated optical beam, to eliminate the analyzer at the exit side of the liquid crystal panel and provide the fluorescent substance on the inner surface of the glass substrate at the exit side of the liquid crystal layer. See for example Japanese Laid-Open Patent Publication 8-29787.

According to this known construction of flat display device, a phase-change-type guest-host (PCGH) liquid crystal or a polymer-dispersion-type liquid crystal (PDLC) is used for the liquid crystal layer forming the liquid crystal panel. In the liquid crystal panel of such a construction, the optical absorption of dichroic dyes introduced in the liquid crystal is used to modulate the incident optical beam of a visual wavelength spatially. Thereby, the optical beam thus modulated is used to excite the fluorescent substance on the inner surface of the glass substrate at the exit side. The foregoing prior art discloses both a reflection type device and a transmission type device.

As the fluorescent substance is provided on the inner surface of the exit-side glass substrate in the flat display device of this prior art, the optical path length of the optical beam reaching the fluorescent substance after spatial modulation becomes minimum in the construction of the foregoing prior art and the problem of mixing of colors is effectively suppressed.

On the other hand, the foregoing flat display device that uses dichroic dyes has a drawback, associated with the use of chiral substance in the liquid crystal layer, in that the response speed of the display device is relatively slow. By introducing the chiral substance to the liquid crystal layer, the dichroic dyes, which are added to the liquid crystal molecules in the liquid crystal layer, are aligned in a spiral pattern when the flat display device is in a non-activated state. Thereby, the dichroic effect of the dyes is maximized.

When the flat display device is activated by applying an electric field to the liquid crystal layer, on the other hand, the liquid crystal molecules are aligned parallel in a predetermined direction, while the transition to the foregoing parallel-aligned state of the liquid crystal molecules takes a time when there is a spiral arrangement in the liquid crystal molecules in the initial, non-activated state.

Further, the flat display device of the foregoing prior art has a drawback in that it is not possible to completely shut the visual optical beam incident to the fluorescent substance by way of spatial modulation.

In addition, the flat display device of the foregoing prior art has a drawback in that it is necessary to use a plurality of different dyes in order to achieve an on-off control of the visual optical beam. In the flat display device of the foregoing prior art, it should be noted that the visual optical beam to be modulated by the liquid crystal panel has a spectrum extending over the entire visual wavelength range, while the absorption wavelength range of a dichroic dye is generally limited. Thereby, there can be a problem in the reliability of representation.

Further, when a PCGH liquid crystal is used for the liquid crystal panel in the foregoing flat display device, there arises a problem of difficulty in representing half-tone images. It should be noted that the change of optical state occurs in a PCGH liquid crystal as a result of a phase change therein.

### SUMMARY OF THE INVENTION

Accordingly, it is a general object of the present invention to provide a novel and useful flat display device wherein the foregoing problems are eliminated.

According to the present invention, it is possible to positively suppress the excitation of the luminescent material in the off-representation mode, by using a ultraviolet beam having a wavelength component shorter than about 500 nm. Thereby, the reliability of representation is improved substantially. As the luminescent material is provided inside the liquid crystal panel, the problem of mixing of color as a result of divergence of the optical beam is successfully avoided.

Other objects and further features of the present invention will become apparent from the following detailed description when read in conjunction with the attached drawings.

### BRIEF DESCRIPTION OF THE DRAWINGS

FIG. 1 is a diagram showing the construction of a flat display device according to a first embodiment of the present invention;

FIG. 2 is a diagram showing a part of the flat display device of FIG. 1 in an enlarged scale;

FIGS. 3A and 3B are cross-sectional diagrams showing the construction of a liquid crystal panel used in the flat display device of FIG. 1 respectively in a non-activated state and in an activated state;

FIGS. 4A-4C are diagrams showing examples of the dichroic dye used in the flat display device of FIG. 1;

FIG. 5 is a diagram showing the spectrum of a blue light emitting diode used in the flat display device of FIG. 1 for an optical source;

FIG. 6 is a diagram showing the construction of the flat display device of FIG. 1 for the case in which a blue light emitting diode is used for the optical source;

FIGS. 7A and 7B are cross-sectional diagrams showing the construction of a liquid crystal panel used in a flat display device according to a second embodiment of the present invention respectively in a non-activated state and in an activated state;

FIGS. 8A and 8B are cross-sectional diagrams showing the construction of a liquid crystal panel used in a flat display device according to a third embodiment of the present invention respectively in a non-activated state and in an activated state;

FIGS. 9A and 9B are cross-sectional diagrams showing the construction of a liquid crystal panel used in a flat display device according to a fourth embodiment of the present invention respectively in a non-activated state and in an activated state;

FIGS. 10A-10C are diagrams showing the construction of a flat display device according to a fifth embodiment of the present invention in comparison with the flat display device of the first embodiment and a conventional flat display device; and

FIG. 11 is a diagram comparing the effect of the first embodiment and the second embodiment.

### DETAILED DESCRIPTION OF THE PREFERRED EMBODIMENTS

[First Embodiment]

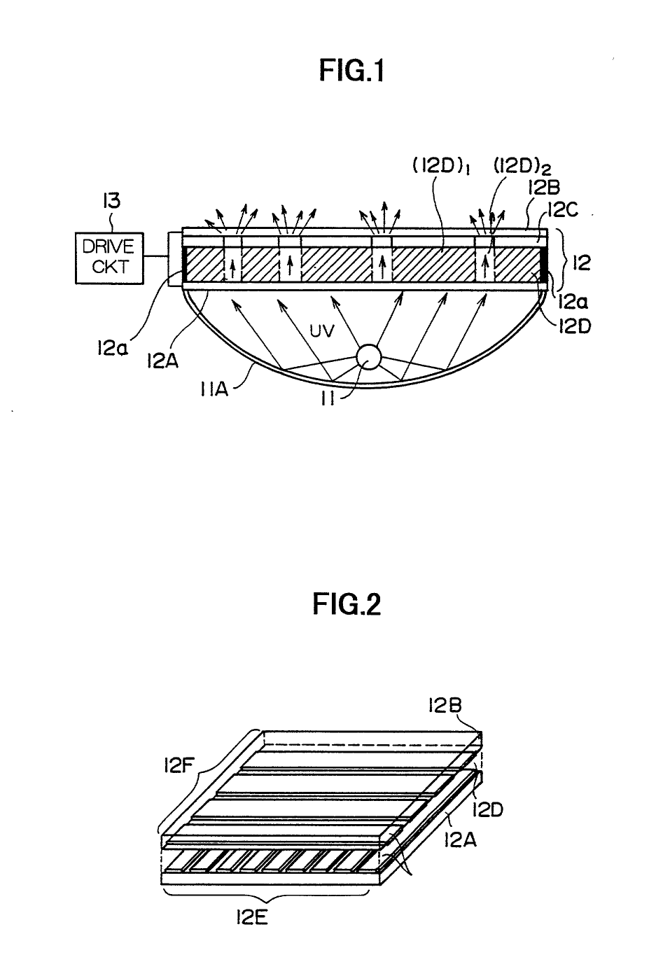

FIG. 1 shows the construction of a flat display device 10 according to a first embodiment of the present invention.

Referring to FIG. 1, the flat display device 10 includes a ultraviolet optical source 11 having a reflector 11A and a liquid crystal panel 12 provided adjacent to the ultraviolet source 11, wherein the liquid crystal panel 12 is driven by a driving circuit 13.

As represented in FIG. 1, the liquid crystal panel 12 includes a glass substrate 12A facing the ultraviolet source 11 and another glass substrate 12B opposing the glass substrate 12A, and a liquid crystal layer 12D of a fluorinated guest-host liquid crystal containing F or a cyanide guest-host liquid crystal containing CN is confined between the glass substrates 12A and 12B with a homogeneous alignment of the liquid crystal molecules. Further, there is provided a luminescent layer 12C of a fluorescent substance or a luminescent dye on an inner surface of the glass substrate 12B. In the construction of FIG. 1, the liquid crystal layer 12D is held in a space formed between the glass substrates 12A and 12B by a seal member 12a.

FIG. 2 shows the construction of the electrodes formed in the liquid crystal panel 12 of FIG. 1.

Referring to FIG. 2, it can be seen that a number of data electrodes 12E of a transparent conductor material such as ITO extend on the inner surface of the glass substrate 12A parallel with each other in a longitudinal direction, and a number of transparent scanning electrodes 12F also of ITO extend on the inner surface of the glass substrate 12B parallel with each other in a transversal direction. In FIG. 2, it should be noted that the illustration of the luminescent layer 12C formed between the scanning electrode 12F and the glass substrate 12B is omitted for the sake of simplicity.

In the electrode structure of FIG. 2, the drive circuit 13 selects one of the transparent scanning electrodes 12F and simultaneously one of the transparent data electrodes 12D. Thereby, a pixel (12D)₂ corresponding to the intersection of the selected scanning electrode 12F and the selected data electrode 12D undergoes a transition to a transparent state, and the part of the luminescent layer 12C corresponding to the foregoing pixel is excited by the ultraviolet beam emitted by the ultraviolet optical source 11. In the unselected pixel such as a pixel (12D)₁, on the other hand, the liquid crystal layer 12D maintains opacity. Thereby, there occurs a photo emission only in the part corresponding to the selected pixel (12D)₂.

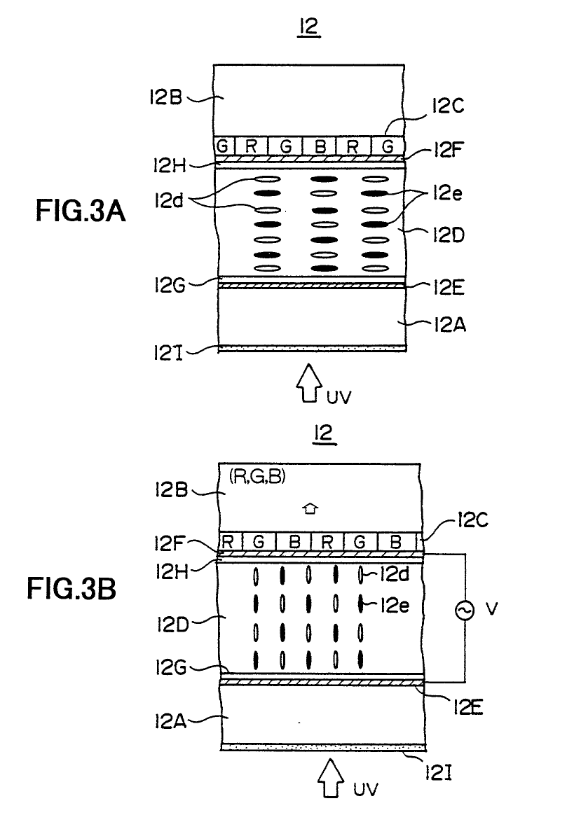

FIGS. 3A and 3B show the details of the liquid crystal panel 12 used in the flat display device 10 of FIG. 1 in a cross-sectional view, wherein FIG. 3A shows the liquid crystal panel corresponding to the pixel (12D)₁ while FIG. 3B shows the liquid crystal panel corresponding to the pixel (12D)₂. As represented in FIG. 1, the pixel (12D)₁ is in the non-activated state, while the pixel (12D)₂ is in the activated state.

Referring to FIG. 3A, the data electrode 12E and the scanning electrode 12F are covered respectively by a molecular alignment film 12G and a molecular alignment film 12H, and the luminescent layer 12C is formed between the scanning electrode 12F and the glass substrate 12B. The luminescent layer 12C is divided to a red region (R), a green region (G) and a blue region (B), wherein such regions of different colors can be formed by a screen printing process of the luminescent dyes or fluorescent materials of the respective colors on the glass substrate 12B.

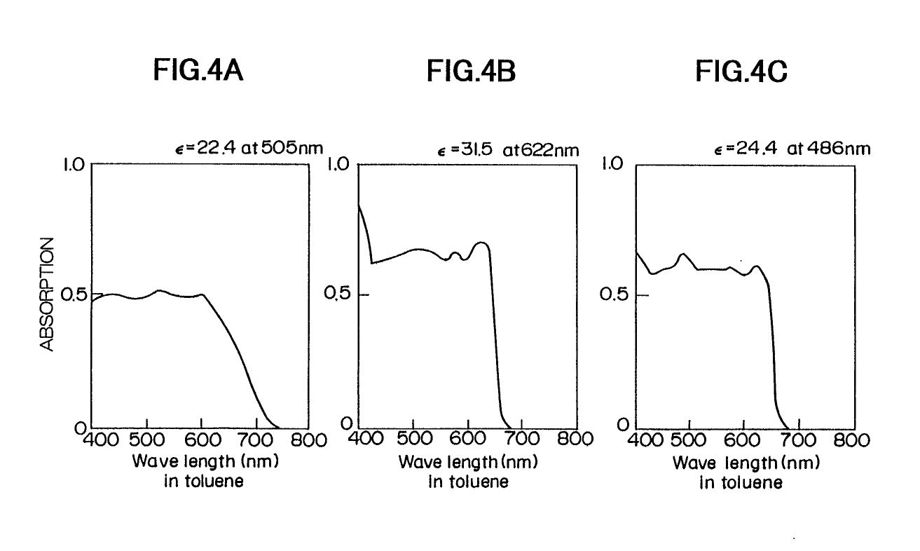

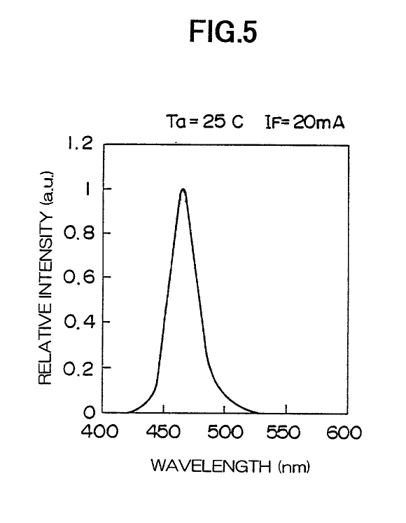

It should be noted that the liquid crystal layer 12D includes liquid crystal molecules 12d and dye molecules 12e, wherein the liquid crystal molecules 12d act as a host while the dye molecules 12e act as a guest. A yellow dye may be used for the dye molecules 12e as will be explained later with reference to FIGS. 4A-4C.

In the state of FIG. 3A in which no drive voltage is applied across the electrodes 12E and 12F, the liquid crystal molecules 12d, and hence the dye molecules 12e, are aligned generally in a plane parallel with the substrates 12A and 12B as a result of the interaction with the molecular alignment films 12G and 12H. The dye molecules 12e are dichroic molecules and absorbs an optical beam having a plane of vibration parallel to the elongating direction of the dye molecules 12e.

As represented in FIGS. 3A and 3B, there is disposed a polarizer 12I between the glass substrate 12A and the ultraviolet optical source 11, wherein the absorption axis of the polarizer 12I extends perpendicularly to the plane of the drawing. Thereby, the ultraviolet beam produced by the ultraviolet optical source 11 and polarized by the polarizer 12I is absorbed by the dye molecules 12 in the non-activated state of FIG. 3A and does not reach the luminescent layer 12C including the dyes R, G and B. In other words, there occurs no photo emission in the luminescent layer 12C in the state of FIG. 3A.

In the state of FIG. 3B, on the other hand, a drive voltage V is applied between the scanning electrode 12F and the data electrode 12E. Thereby, the liquid crystal molecules 12d, and hence the dichroic dyes 12e, are aligned in the liquid crystal layer 12D generally perpendicularly to the plane of the liquid crystal layer 12D and the ultraviolet beam thus polarized by the polarizer 12I reaches the luminescent layer 12C through the liquid crystal layer 12D without being absorbed substantially by the dye molecules 12e.

In the flat display device 10 of the present embodiment, it should be noted that the liquid crystal molecules 12d and the dye molecules 12e are aligned parallel with each other in a predetermined direction in the non-activated state of FIG. 3A. Thus, the transient time needed for the liquid crystal molecules 12d to undergo a transition from the non-activated state of FIG. 3A to the activated state of FIG. 3B, is reduced substantially in the flat display device 10, as compared with the conventional flat display device in which there occurs a spiral arrangement of the PCGH liquid crystal molecules in the non-activated state.

As the flat display device 10 of the present embodiment uses the ultraviolet optical source 11 in place of an optical source of visual wavelength, the dichroic dye molecules 12e are merely required to absorb the ultraviolet wavelength radiation and it is no longer necessary, in the flat display device 10 of the present embodiment, to use different dyes of different absorption wavelengths. Thereby, the problem of unwanted photo emission of the luminescent layer 12C in the non-activated state is effectively eliminated. In other words, the flat display device 10 of the present embodiment shows an excellent reliability.

In the flat display device 10 of the present embodiment, the luminescent layer 12C is formed inside the liquid crystal panel 12. Thereby, the ultraviolet beam spatially modulated by the guest-host liquid crystal layer 12D reaches the luminescent layer 12C with minimum distance. Thus, the mixing of the R, G and B colors caused by the divergence of the spatially modulated ultraviolet beams is successfully minimized.

FIGS. 4A-4C show the absorption spectra of various yellow dyes usable for the dye molecule 12e, wherein FIG. 4A represents the absorption spectrum of a commercially available yellow color dye (S-426 of Mitsui Toatsu Kagaku, K.K.).

Referring to FIG. 4A, the dye absorbs the optical component having a wavelength shorter than about 750 nm and shows a generally constant absorption of about 50% in the wavelength range of about 600 nm or shorter.

FIG. 4B, on the other hand, shows the absorption spectrum of another commercially available yellow color dye (S-428 also of Mitsui Toatsu Kagaku, K.K.), wherein it can be seen that the dye shows a very large absorption in the wavelength range shorter than about 650 nm.

Further, FIG. 4C shows the absorption spectrum of a further commercially available yellow color dye (S-429 also of Mitsui Toatsu Kagaku, K.K.), wherein it can be seen that the dye shows a very large absorption in the wavelength range shorter than about 650 nm similarly to the dye of FIG. 4B.

Thus, it is appropriate, when the dichroic dye of FIGS. 4A-4C is to be used for the guest-host liquid crystal layer 12D, to use a high-pressure mercury-vapor lamp producing a radiation with a wavelength range smaller than about 600 nm.

Alternatively, it is possible to use a commercially available blue-color LED having a photo emission spectrum of FIG. 5. Such a blue-color LED is available from Nichia Kagaku, K.K. with the trade name of NSCB100. As can be seen, the photo emission spectrum of FIG. 5 has a maximum intensity at the wavelength of about 460 nm.

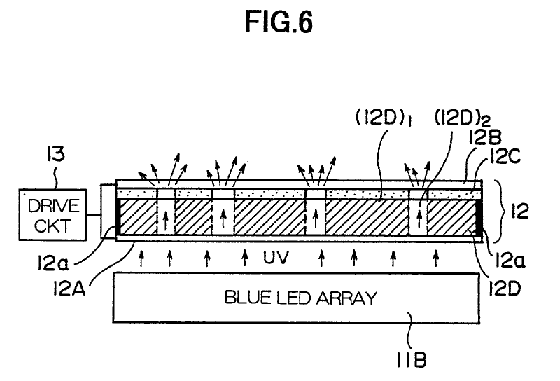

When such a blue LED is to be used for the optical source 11, it is desirable to form a two-dimensional array 11B of the LEDs as represented in FIG. 6, wherein it can be seen that the LED array 11B is disposed adjacent to the liquid crystal panel 12 in place of the ultraviolet optical source 11.

The lower limit wavelength of the ultraviolet optical source 11 may be about 200 nm, depending on the available optical source.

[Second Embodiment]

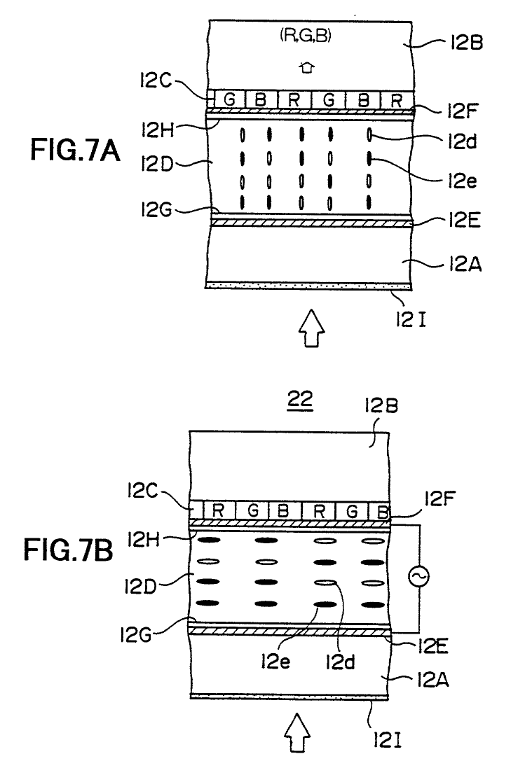

FIGS. 7A and 7B are diagrams showing the construction of a liquid crystal panel 22 used in a flat display device according to a second embodiment of the present invention, wherein those parts corresponding to the parts described previously are designated by the same reference numerals and the description thereof will be omitted.

Referring to FIGS. 7A and 7B, the flat display device of the present embodiment has a construction generally similar to that of the flat display device 10 of FIG. 1, except that the liquid crystal panel 12 of FIG. 1 is replaced with the liquid crystal panel 22 of FIGS. 7A and 7B. Similarly to FIGS. 3A and 3B, FIG. 7A represents the non-activated state of the liquid crystal panel 22, while FIG. 7B represents the activated state.

In the present embodiment, a guest-host liquid crystal of homeotropic alignment is used for the liquid crystal layer 12D in place of the liquid crystal of the homogeneous alignment guest-host liquid crystal used in the previous embodiment. In the homeotropic liquid crystal layer 12D, it should be noted that the liquid crystal molecules align generally perpendicularly to the plane of the liquid crystal layer 12D in the non-activated state of the liquid crystal panel 12 of FIG. 7D, while the liquid crystal molecules are aligned generally parallel to the plane of the liquid crystal layer 12D in the activated state of FIG. 7B. As a result, a photo emission occurs in the luminescent layer 12C in the non-activated state of the liquid crystal panel 12 shown in FIG. 7A, while in the activated state of FIG. 7B, the photon emission is effectively suppressed.

Other constructions and features are substantially identical with those of the previous embodiment and further description thereof will be omitted.

[Third Embodiment]

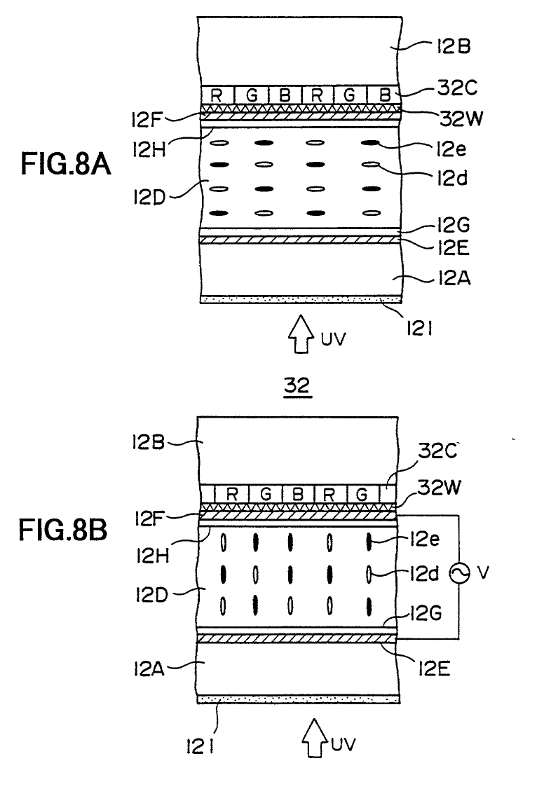

FIGS. 8A and 8B show the construction of a liquid crystal panel 32 used in a flat display device according to a third embodiment of the present invention, wherein those parts corresponding to the parts described previously are designated by the same reference numerals and the description thereof will be omitted.

Referring to FIGS. 8A and 8B, the flat display device of the present embodiment has a construction generally similar to that of the flat display device 10 of FIG. 1, except that the liquid crystal panel 12 of FIG. 1 is replaced with the liquid crystal panel 32 of FIGS. 8A and 8B. Similarly to FIGS. 3A and 3B, FIG. 8A represents the non-activated state of the liquid crystal panel 32, while FIG. 8B represents the activated state.

In the present embodiment, a guest-host liquid crystal of the homogeneous alignment is used for the liquid crystal layer 12D similarly to the case of the first embodiment of FIGS. 3A and 3B, wherein it can be seen, in FIGS. 8A and 8B, that the luminescent layer 12C between the scanning electrode 12F and the glass substrate 12B is replaced with a white luminescent layer 32W, and color filters 32C of R, G and B are disposed between the white luminescent layer 32W and the substrate 12B.

In the construction of FIGS. 8A and 8B, the white luminescent layer 32W is optically excited by the ultraviolet beam UV from the ultraviolet optical source 11 to produce a white photo emission according to the desired spatial modulation pattern. The white photo emission thus produced is then colored by the color filters 32C and exits from the glass substrate 12B.

Other constructions and features are substantially identical with those of the previous embodiment and further description thereof will be omitted.

[Fourth Embodiment]

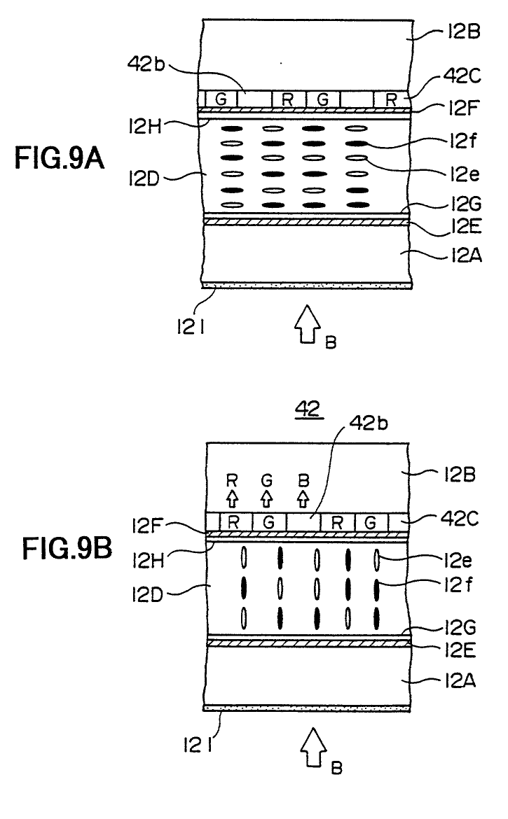

FIGS. 9A and 9B show the construction of a liquid crystal panel 42 used in a flat display device according to a fourth embodiment of the present invention, wherein those parts corresponding to the parts described previously are designated by the same reference numerals and the description thereof will be omitted.

Referring to FIGS. 9A and 9B, the flat display device of the present embodiment has a construction generally similar to that of the flat display device 10 of FIG. 1, except that the liquid crystal panel 12 of FIG. 1 is replaced with the liquid crystal panel 42 of FIGS. 9A and 9B. Similarly to FIGS. 3A and 3B, FIG. 9A represents the non-activated state of the liquid crystal panel 42, while FIG. 9B represents the activated state.

In the present embodiment, the blue optical source of FIG. 6 is used in place of the ultraviolet optical source 11 of FIG. 1, and a luminescent layer 42C is used in place of the luminescent layer 12C, wherein the luminescent layer 42C has a construction similar to that of the luminescent layer 12C except that a blue (B) luminescent element is selectively eliminated in correspondence to a region 42b. In the construction of the present embodiment, the blue optical beam produced by the blue optical source is caused to pass through the foregoing region 42b as it is in the activated state shown in FIG. 9B.

According to the present embodiment, the blue optical beam passes through the luminescent layer 42C without being filtered or absorbed. Thereby, a high luminosity representation is obtained particularly to the blue color.

[Fifth Embodiment]

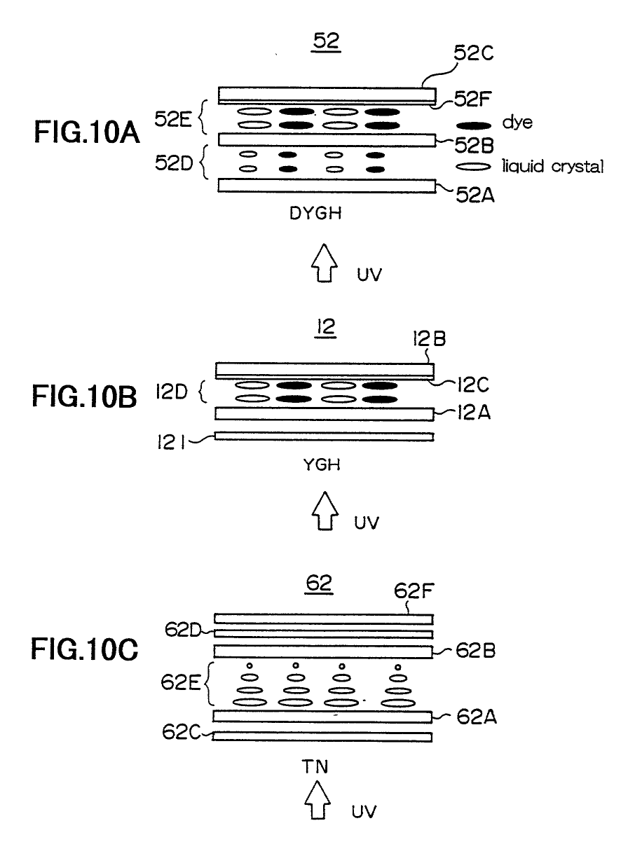

FIG. 10A shows the construction of a liquid crystal panel 52 for use in a flat display device according to a fifth embodiment of the present invention.

Referring to FIG. 10A, the liquid crystal panel 52 includes a first glass substrate 52A facing the ultraviolet optical source 11 not illustrated and a second glass substrate 52B opposing the first glass substrate 52A. Further, there is provided a third glass substrate 52C at the side of the glass substrate 52B away from the first glass substrate 52A. Thereby, there is provided a liquid crystal layer 52D of homogeneous guest-host liquid crystal between the glass substrates 52A and 52B in correspondence to the liquid crystal layer 12D, and a homogeneous liquid crystal layer 52E is confined between the glass substrate 52B and the glass substrate 52C also in correspondence to the liquid crystal layer 12D. Further, the glass substrate 52C carries, on the inner surface thereof, a luminescent layer 52F corresponding to the luminescent layer 12C. In FIG. 10A, illustration of the data electrode 12E or the scanning electrode 12F is omitted for the sake of simplicity. Further, the molecular alignment films formed on the inner surfaces of the glass substrates 52A-52C are also omitted from illustration.

In the liquid crystal panel 52 of FIG. 10A, it should be noted that the liquid crystal molecules in the liquid crystal layer 52D are aligned substantially perpendicularly to the liquid crystal molecules, and hence the dye molecules, in the liquid crystal layer 52. Thereby, the ultraviolet beam traveling toward the luminescent layer 52C is absorbed effectively by the dye molecules introduced in the liquid crystal layer 52D or 52E as a guest, as long as the liquid crystal panel 52 is in the non-activated state, even when the polarizer 12I in the first embodiment is omitted.

When a driving electric field is applied across the scanning electrode and the data electrode in each of the liquid crystal layers 52D and 52E, on the other hand, the liquid crystal molecules and hence the dye molecules align generally perpendicularly to the plane of the liquid crystal layers and the ultraviolet beam reaches the luminescent layer 52F.

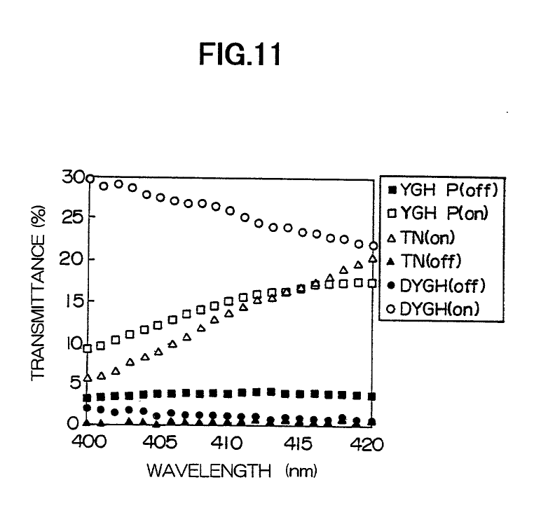

FIG. 11 compares the transmittance of the liquid crystal panel 52 of FIG. 10A in comparison with the transmittance of the liquid crystal panel 12 of FIG. 10B and further with the transmittance of a normal twist-nematic (TN) mode liquid crystal panel represented in FIG. 10C, wherein the open circles and solid circles represent the transmittance respectively in the activated state and in the non-activated state for the liquid crystal panel 52, while the open squares and solid squares represent the transmittance respectively in the activated state and in the non-activated state of the liquid crystal panel 12. Further, the open triangles and solid triangles represent the transmittance respectively in the activated state and in the non-activated state of the TN-mode liquid crystal panel of FIG. 10C. In the TN-mode liquid crystal panel of FIG. 10C, it should be noted that a liquid crystal layer 62 is held between a pair of glass substrates 62A and 62B, wherein the glass substrates 62A and 62B carry, on the respective outer sides thereof, a pair of polarizers 62C and 62D as usual in the art. The liquid crystal layer 62 is free from dye molecules and the luminescent layer 62F is disposed at the outer side of the polarizer 62D.

Referring to FIG. 11, the flat display device of the first embodiment of the present invention that uses the liquid crystal panel 12 shows an improved transmittance over the conventional flat display device that uses the conventional TN-mode liquid crystal panel of FIG. 10C, particularly at the short wavelength region. Associated with this, the flat display device of the first embodiment provided a superior luminosity over the conventional flat display device.

In the case of the flat display device of the present embodiment, in which the liquid crystal panel 62 of FIG. 10A is used, it can be seen that the transmittance of the liquid crystal panel is significantly improved in the short wavelength range over any of the construction of FIG. 10B or FIG. 10C. Thus, the flat display device of the present embodiment provides a very high luminosity representation of images.

In the flat display device of the present invention, it should be noted that the liquid crystal confined in the liquid crystal panel is by no means limited to the homogeneous guest-host liquid crystal or the homeotropic liquid crystal, but other liquid crystal such as a PCGH mode liquid crystal may also be used.

Further, the present invention is not limited to the embodiments described heretofore, but various variations and modifications may be made without departing from the scope of the invention.

What is claimed is:

1. A display device, comprising:
an optical source producing an optical beam with a wavelength shorter than about 500 nm;
a liquid crystal panel disposed adjacent to said optical source for controlling said optical beam; and
a layer of luminescent substance provided inside said liquid crystal panel.

2. A display device as claimed in claim 1, wherein said layer of luminescent substance includes therein a plurality of pixels, each pixel including a red region including a red luminescent substance, a green region including a green luminescent substance, and a blue region including a blue luminescent substance.

3. A display device as claimed in claim 1, wherein said layer of luminescent substance includes a while luminescent substance, said display device further including a red filter, a green filter and a blue filter formed on said layer of luminescent substance.

4. A display device as claimed in claim 1, wherein said liquid crystal panel includes a first substrate facing said optical source, a second substrate opposing said first substrate, a liquid crystal layer of a homogeneously aligned guest-host liquid crystal confined between said first and second substrates, said layer of luminescent substance being formed on a surface of said second substrate facing said liquid crystal layer.

5. A display device as claimed in claim 1, wherein said liquid crystal panel includes a first substrate facing said optical source, a second substrate opposing said first substrate, a liquid crystal layer of a homeotropically aligned guest-host liquid crystal confined between said first and second substrates, said layer of luminescent substance being formed on a surface of said second substrate facing said liquid crystal layer.

6. A display device as claimed in claim 1, wherein said liquid crystal panel includes a first substrate facing said optical source, a second substrate opposing said first substrate, a liquid crystal layer of a phase-change type liquid crystal confined between said first and second substrates, said layer of luminescent substance being formed on a surface of said second substrate facing said liquid crystal layer.

7. A display device as claimed in claim 1, wherein said liquid crystal panel includes a first substrate facing said optical source, a second substrate opposing said first substrate, a third substrate opposing said second substrate at a side away from said first substrate, a liquid crystal layer of a homonegeously aligned liquid crystal confined in a first gap formed between said first and second substrates and in a second gap formed between said second and third substrates, said layer of luminescent substance being formed on a surface of said third substrate facing said liquid crystal layer filling said second gap.

8. A display device as claimed in claim 4, wherein said guest-host liquid crystal contains a dichroic dye absorbing ultraviolet radiation.

9. A display device as claimed in claim 4, wherein said guest-host liquid crystal contains a dichroic dye absorbing both ultraviolet radiation and visible wavelength radiation.

10. A display device as claimed in claim 4, further including a polarizer between said optical source and said first substrate with an orientation such that an absorption axis of said polarizer, intersects substantially perpendicularly to an absorption axis of a dichroic dye molecule contained in said liquid crystal layer in the state in which said dichroic dye molecules are generally aligned parallel to said first and second substrates.

11. A display device as claimed in claim 7, wherein said homogeneously aligned guest-host liquid crystal contains dye molecules such that an absorption axis of said dye molecules in said liquid crystal layer confined in said first gap and an absorption axis of said dye molecules in said liquid crystal layer confined in said second gap intersect substantially perpendicularly in the state in which liquid crystal molecules of said liquid crystal layer confined in said first gap and liquid crystal molecules confined in said second gap are aligned generally parallel in a plane of said first substrate.
